(19) United States
(12) Patent Application Publication
(10) Pub. No.: US 2008/0012348 A1
(43) Pub. Date: Jan. 17, 2008

(54) Sanding Device for Rail Vehicles

(76) Inventor: Rainer Knoss, Muenchen (DE)

Correspondence Address: BARNES & THORNBURG LLP, 750-17TH STREET NW, SUITE 900, WASHINGTON, DC, 20006-4675, US

(21) Appl. No.: 10/593,952

(22) PCT Filed: Mar. 22, 2005
(86) PCT No.: PCT/EP05/03024

§ 371 Date: Jun. 29, 2007

(30) Foreign Application Priority Data
Mar. 24, 2004 (DE) 10 2004 014 360.9

(51) Int. Cl. B60B 39/00

(52) U.S. Cl. 291/25

(57) ABSTRACT

The present disclosure relates to a sanding device for a vehicle. The sanding device includes a compressed-air connection, at least one pneumatic valve, a pressure container and a sanding nozzle arranged in a sand container.

### BACKGROUND AND SUMMARY

The present disclosure relates to a sanding device for vehicles, particularly for rail vehicles. In order to improve the coefficient of adhesion between the wheels and the running surface under unfavorable running surface conditions, vehicles are equipped with sanding systems. In the case of rail vehicles, sanding systems contribute to considerably increasing the coefficient of adhesion between the wheels and the rails within a short time.

In the case of rail vehicles, the sand is discharged in front of the wheels, so that the rail vehicles roll by way of a “sanded” rail with a considerably increased coefficient of adhesion. The effect of the sanding is a function of the quantity of the discharged sand per covered running path. Ideally, a constant quantity of sand should be discharged per meter of running path. If an insufficient quantity of sand is discharged, the full effect of the improvement of the coefficient of adhesion is not achieved. If, on the other hand, too much sand is discharged, there is also no optimal effect.

Switches are even occasionally clogged by too much sand, which results in operating disturbances. A large amount of sand may severely interfere with the track facilities. A clogging of track switches by sand may drastically impair the conductance between the wheels and the rails which is important for the signal transmission. Such a deterioration of the conductance between the wheels and the rails has the risk that, in the event of improper care of the track facilities, the signal transmission may be impaired such that, in the worst case, a signal transmission does not take place or is faulty, so that accidents may occur.

The present disclosure relates to improving the adhesion between the wheels and the rail in the case of ice and wetness, without the occurrence of disturbances.

German Patent Document DE 34 10 409 shows a sanding system in which the sand quantity is apportioned by a pulsating volumetric pump.

German Patent Document DE 100 44 608 shows a sanding device where compressed air is blown in a pulsating manner into the sand outlet of a sand container and, as a result, the sand quantity is apportioned. The sand quantity moved into the area of the downpipe is then blown out by a separate compressed-air current.

The present disclosure relates to providing a simpler and more economical method of apportioning the discharged quantity.

Thus, the present disclosure relates to a sanding device including a compressed-air connection to receive compressed-air at a high pressure level. Also included is a first pneumatic valve having one input and a first and a second output and a second pneumatic valve having two inputs and one output. Further included is a pressure container and a sanding nozzle arranged in a sand container, and wherein: a) the compressed-air connection is connected with the input of the first pneumatic valve; b) one of the two outputs of the first pneumatic valve is connected with the pressure container; c) the pressure container is connected with one of the two inputs of the second pneumatic valve; d) the other output of the first pneumatic valve is connected with the other output of the second pneumatic valve; and e) the output of the second pneumatic valve is connected with the sanding nozzle.

The present disclosure is based on an idea of providing the compressed air flowing into the sanding device, which is to be controlled in a continuous manner by switching the compressed-air supply on and off, and smoothed by way of a pressure container. It thereby becomes possible to make the discharge quantity dependent on the vehicle speed.

The present disclosure provides a sanding device which can discharge different quantities of sand as a function of the input pressure. The faster the rail vehicle travels, the more sand is discharged. According to the present disclosure, switching between two different sanding levels no longer takes place. Thus, according to the present disclosure, precisely the correct amount of sand no longer is present only at two speeds. Most importantly, when the travel is very slow, the discharged quantity of sand is no longer extremely high in comparison to the quantity of sand which would actually be needed. According to the present disclosure, the refilling of sand also becomes less frequent. It becomes possible to discharge the same quantity of sand per traveled meter. The present disclosure provides a system which is not susceptible to disturbances and operates continuously with compressed air.

Other aspects of the present disclosure will become apparent from the following descriptions when considered in conjunction with the accompanying drawings.

### BRIEF DESCRIPTION OF THE DRAWINGS

FIG. 1 is a schematic view of a sanding device according to the present disclosure;

FIG. 2 is a view of a signal form for a solenoid valve of the sanding device of FIG. 1.

### DETAILED DESCRIPTION

A sanding device according to the present disclosure includes a pressure reducing valve 1 to which the pressure from a pneumatic braking system of a rail vehicle is applied. Also included is a first pneumatic valve 2 in the form, for example, of a 3/2-way valve, a second pneumatic valve 3 in the form, for example, of a 3/2-way valve, a pressure container 4, a sanding nozzle 5 which is arranged in a sanding container 16, and a brake control device 6.

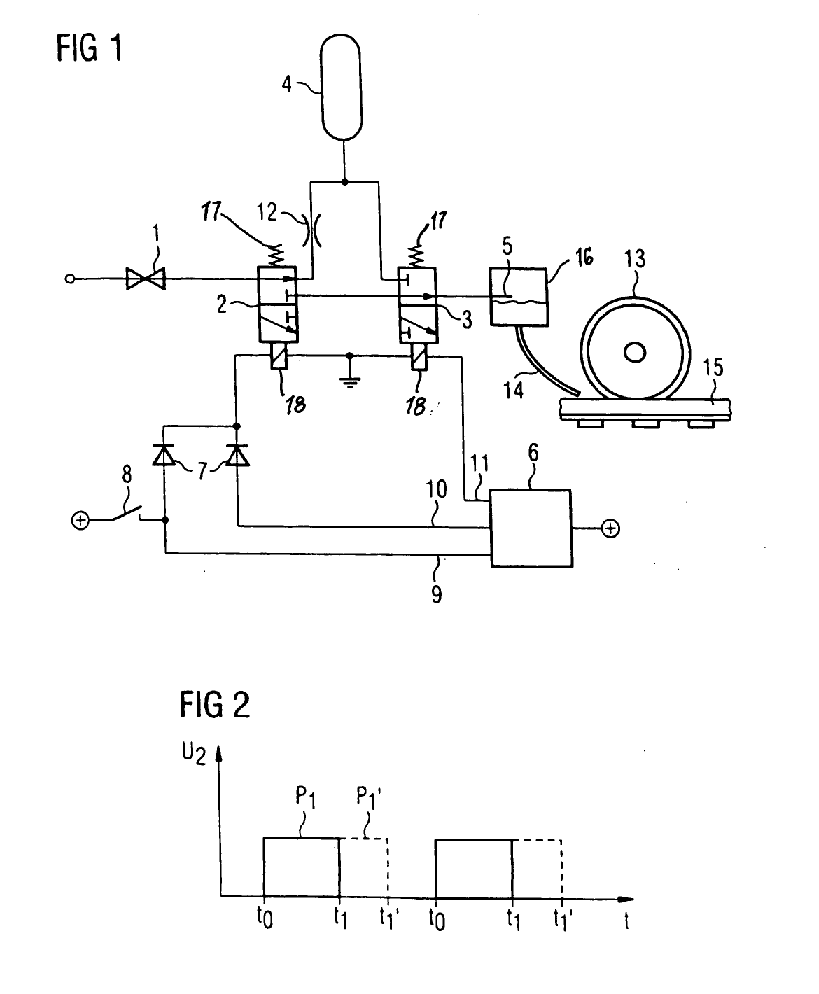

The output of the pressure reducing valve I is shown, for example, in FIG. 1, connected with an input of the first 3/2-way valve 2. One of two outputs of the first 3/2-way valve 2 is connected by way of a throttle 12 with a connection of the pressure container 4. This connection of the pressure container 4 is connected with one of two inputs of the second 3/2-way valve 3. The other of the two outputs of the first 3/2-way valve 2 is shown connected with the other of the two inputs of the second 3/2-way valve 3. An output of the second 3/2-way valve 3 is connected with the sanding nozzle 5.

As shown in FIG. 1, the first 3/2-way valve 2 is constructed such that, in an inoperative position, the input of valve 2 is connected with one of the two outputs which leads to the pressure container 4. The other output of valve 2 that leads to the second 3/2-way valve 3 will then be blocked. In an operative position of the first 3/2-way valve 2 (not shown), the input from pressure reducing valve 1 is connected with the output of valve 2 which leads to one of the two inputs of the second 3/2-way valve 3. The output of valve 2 leading to the pressure container 4 will then be blocked.

The second 3/2-way valve 3 is constructed such that, in an inoperative position, as shown in FIG. 1, the input connected with one of the outputs of the first 3/2-way valve 2 is connected with the output of the second 3/2-way valve 3. The input from the pressure container 4 will then be blocked. In an operative position of the second 3/2-way valve 3 (not shown), the input of valve 3 from the pressure container 4 is open and is connected with the output of valve 3 leading to the sanding nozzle 5. The other input to the first 3/2-way valve 2 will then be blocked.

As shown in FIG. 1, only one wheel 13 of the rail vehicle is illustrated on a rail section 15. For a precise application of sand into a space between the wheel 13 and the rail section 15, a blow-out pipe 14, from which the sand exits, is provided on the sand container 16.

The first 3/2-way valve 2 and the second 3/2-way valve 3 can each be actuated by an electrically excitable coil against the pressure of a spring 17. Each of the coils 18 can be automatically supplied with electric power by the brake control device 6. The coil 18 of the first 3/2-way valve 2 can also be supplied manually upon a demand by a driver by way of a sanding key button 8. Whereupon the first 3/2-way valve 2 or the second 3/2-way valve 3 is changed from the inoperative state into the operative state. From the brake control device 6, a first control line 10 leads to the first 3/2-way valve 2; a second control line 11 leads to the second 3/2-way valve 3. In addition, a scanning line 9 is provided by way of which the switching condition of the sanding key button 8 can be determined by the brake control device 6.

Blocking diodes 7 prevent a mutual influencing of the first control line 10 and of the scanning line 9. Otherwise, an electric signal present on the first control line 10 would be interpreted on the scanning line 9 as an operation of the sanding switch 8, which is not correct.

The sanding device according to the present disclosure operates as follows.

During a start of the operation of the rail vehicle, the sanding device is without compressed air. At the input of the pressure reducing valve 1, a compressor pressure of approximately 8.5 bar is present, which is reduced to a constant pressure of 6 bar. Subsequently, the pressure container 4 starts to fill with compressed air by way of the first 3/2-way valve 2 and the throttle 12. The second 3/2-way valve 3 blocks the path of the compressed air from the pressure container 4 to the sanding nozzle 5, so that no compressed air exits there.

When the brake control device 6 now determines that sanding has to take place, for example, during a rapid-stop demand or in the case of antiskid interventions or by way of rotational speed sensors at the wheel 13, the second 3/2-way valve 3 is actuated by way of the second control line 11. As a rule, the rail vehicle travels at a relatively high speed here.

Subsequently, compressed air at an initial pressure of 6.5 bar exits from the pressure container 4 through the second 3/2-way valve 3 and reaches the sanding nozzle 5. Compressed air is then blown at a relatively high velocity into the sanding container 16. The compressed air exiting there pulls sand along with it which then exits from the blow-out pipe 14.

The quantity of the sand exiting there can be controlled, specifically by a pulsed operation of the first 3/2-way valve 2, according to the graphic in FIG. 1. For this purpose, the brake control device 6 acts upon the first 3/2-way valve 2 by way of the first control line 10 with a pulsed control voltage. By the resulting opening and closing of the first 3/2-way valve 2, the quantity of the compressed air of 6.5 bar following into the pressure container 4 is adjusted such that a desired lower pressure occurs at the sanding nozzle 5. In this case, the throttle 12 and the pressure container 4 are used for the smoothing of the pressure surges which are caused by the pulsed operation of the first 3/2-way valve 2.

The lower the pressure present at the sanding nozzle 5, the lower the occurring volume flow of compressed air and the lower the quantity of sand per time unit blown out from the blow-out pipe 14.

When the sanding is to be terminated, the first 3/2-way valve 2 and the second 3/2-way valve 3 are switched currentless again, so that an above-described inoperative state occurs again.

When, on the basis of his experience, the driver determines that sanding has to take place, he operates the sanding key button 8, so that the first 3/2-way valve 2 is switched.

Subsequently, compressed air at an initial pressure of 6.5 bar exits from the pressure reducing valve or device I through the first 3/2-way valve 2 and through the second 3/2-way valve 3 and arrives at the sanding nozzle 5. Then compressed air is blown into the sand container 16 at high velocity. The compressed air exiting there pulls the sand along with it, which then exits from the blow-out pipe 14.

To a limited extent, the driver can influence the quantity of sand exiting there, specifically by a manually pulsed operation of the first 3/2-way valve 2.

When the sanding is to be terminated, the driver releases the sanding key button 8, and the first 3/2-way valve 2 is switched currentless again, so that the above-described inoperative position is restored.

When a sanding demand by the driver by operating the sanding key button 8 and a sanding demand by the brake control device 6 are present simultaneously, the sanding demand by the driver has priority.

The brake control device 6 detects the operation of the sanding key button 8 by way of the signal present at the scanning line 9. Subsequently, the first control line 10 to the first 3/2-way valve 2 and the second control line 11 to the second 3/2-way valve 3 are switched currentless. The second 3/2-way valve 3 moves into its inoperative state. However, because of the operation of the sanding key button 8, the first 3/2-way valve 2 remains in its operative position, so that, as described above, the compressed-air flow occurs.

As an alternative, it is more secure for the sanding key button 8 to simultaneously close the connection to the 3/2-way valve 2 and in the process simultaneously interrupt the connection to the 3/2-way valve 3.

When the brake control device 6 detects that the sanding key button 8 is no longer operative, a switching-over takes place again to the automatic operating mode.

A further development, according to the present disclosure, provides for a rapid filling of the compressed-air pipes to the sanding nozzle 5 during the manual as well as the automatic operation. This is advantageous because the air in the sand container 16 first has to build up a certain pressure before the sand starts to flow. Because of the existing pipe lengths, it may nevertheless take up to a second until, after a sanding demand, the first sand comes out of the blow-out pipe 14. The present disclosure relates to a sanding device that permits keeping this time as short as possible.

Another advantage of the sanding device according to the present disclosure is that, when the rail vehicle is traveling, for example, at half its maximum speed and when the timing switches to a “half pressure” of approximately 3 bar, the full pressure is nevertheless present in the pressure container 4 from the start. This is then first followed by a pressure surge, for example, of initially 6.5 bar, which will then be reduced to the 3 bar generated by the timing of the first 3/2-way valve 2. This pressure surge can then rapidly fill the pipes and the sanding container 16 at this high speed, before the sand is blown out at a lower pressure.

Also when traveling at a slow speed, the sanding can therefore rapidly take place by a lower sanding volume flow.

Although the present disclosure has been described and illustrated in detail, it is to be clearly understood that this is done by way of illustration and example only and is not to be taken by way of limitation. The scope of the present disclosure is to be limited only by the terms of the appended claims.

1. A sanding, device for a vehicle, the sanding device comprising:
a compressed-air connection to receive compressed-air at a high pressure level;
a first pneumatic valve having one input and a first and a second output;
a second pneumatic valve having two inputs and one output;
a pressure container;
a sanding nozzle arranged in a sand container; and
wherein
a) the compressed-air connection is connected with the input of the first pneumatic valve,
b) one of the two outputs of the first pneumatic valve is connected with the pressure container,
c) the pressure container is connected with one of the two inputs of the second pneumatic valve,
d) the other output of the first pneumatic valve is connected with the other output of the second pneumatic valve, and
e) the output of the second pneumatic valve is connected with the sanding nozzle.

2. The sanding device according to claim 1, wherein in an inoperative position, the input of the first pneumatic valve is connected with the output of the first pneumatic valve that leads to the pressure containers, the other output of the first pneumatic valve that leads to the second pneumatic valve is blocked, and in an operative position of the first pneumatic valve, the input of the first pneumatic valve is connected with the output of the first pneumatic valve that leads to one of the two inputs of the second pneumatic valve, and the output of the first pneumatic valve leading to the pressure container is blocked.

3. The sanding device according to claim 1, wherein the second pneumatic valve is constructed such that, in an inoperative position, one of the two inputs of the second pneumatic valve connected with one of the outputs of the first pneumatic valve is connected with the output of the second pneumatic valve, the input of the second pneumatic valve from the pressure container blocked, and an operative position of the second pneumatic valve, the input of the second pneumatic valve from the pressure container is open and the output of the second pneumatic valve is connected with the sanding nozzle, and the other input of the second pneumatic valve connected with the first pneumatic valve is blocked.

4. The sanding device according to claim 1, wherein the first pneumatic valve and the second pneumatic valve are each be activated by an electrically excitable coil against the pressure of a spring.

5. The sanding device according to claim 1, further including a brake control device is to activate the first pneumatic valve and the second pneumatic valve.

6. The sanding device according to claim 4, wherein the coil of the first pneumatic valve is configured to be manually supplied with electric power by demand by a driver via a sanding key button.

7. The sanding device according to claim 6, wherein a scanning line is provided from the sanding key button to a brake control device.

8. The sanding device of claim 1, wherein the compressed-air connection is connected with a compressed-air pipe of a brake system.

9. The sanding device of claim 1, wherein the vehicle is a rail vehicle.

10. A method of automatically sanding a rail area configured to lie beneath a wheel of a rail vehicle, the method steps comprising:
providing sand arranged in a sand container;
providing compressed-air from a compressed-air source;
providing a closed pressure container;
feeding pulsed compressed-air from the compressed-air source automatically to the pressure container;
smoothing pressure surges of the pulsing of the compressed-air;
outputting the smoothed compressed-air from the pressure container to the sand container; and
automatically sanding the rail area with sand from the sand container.

11. The method according to claim 10, further including a manual intervention step by a driver that has priority over the automatic sanding step, in that compressed air is fed to the sand container directly from the compressed-air source.
